(19) United States
(12) Patent Application Publication
(10) Pub. No.: US 2010/0100280 A1
(43) Pub. Date: Apr. 22, 2010

(54) Vehicle Leveling And Attitude Positioning System

(75) Inventors: Charles Lee Flynn, Davisburg, MI (US); Christopher E. Curtis, Shelby Township, MI (US)

Correspondence Address: DICKINSON WRIGHT PLLC, 1875 Eye Street, NW, Suite 1200, WASHINGTON, DC, 20006, US

(73) Assignee: DURA GLOBAL TECHNOLOGIES, INC., Rochester Hills, MI (US)

(21) Appl. No.: 12/255,812

(22) Filed: Oct. 22, 2008

(51) Int. Cl. G05D 1/00

(52) U.S. Cl. 701/36

(57) ABSTRACT

A vehicle leveling assembly includes a plurality of jack assemblies corresponding to four quadrants of a vehicle, and a plurality of sensors for determining jack position and rate of movement. A method of detecting contacting between the shafts of the jack assemblies and the ground includes measuring pulse width of current emitted by the hall effect sensor to monitor the speed of the shafts and recognizing contact with the ground when the shaft slows down. A method of detecting contacting between the shafts of the jack assemblies and the ground includes measuring the electric motor current signal and correlating a pulse from the current signal to the electric motor revolutions per minute and travel of the shafts. A method of calibrating the leveling assembly includes measuring a change in inclination as the jack assemblies are extended a known distance to determine the distance between the Jack assemblies. A method of leveling includes extending the shafts an additional compacting distance to ensure accurate calculations of shaft extension, prior to attempting to level the vehicle.

### BACKGROUND OF THE INVENTION

1. Field of the Invention

The subject invention relates generally to a vehicle leveling assembly and methods for operating the vehicle leveling assembly.

2. Description of the Prior Art

Known vehicle leveling assemblies, including leveling assemblies for recreational vehicles, use a plurality of jack assemblies and an inclination sensor assembly attached to a vehicle structure. The jack assemblies each include an actuator assembly for translating a shaft along an axis to adjust vehicle attitude. For example, U.S. Pat. No. 6,584,385, and U.S. Pat. No. 6,885,924, both issued to Ford et al., disclose the use of inclination sensor data and adjustable jack assemblies.

### SUMMARY OF THE INVENTION AND ADVANTAGES

The invention provides for a vehicle leveling assembly including a plurality of jack assemblies for attachment to a vehicle structure. The jack assemblies include a shaft extending along an axis, and an actuator assembly for translating the shaft along the axis. The jack assemblies also include an integrated position sensor for measuring a rate of movement of the shaft along the axis.

The invention also provides a method of detecting contact with the ground including determining an operating speed of the actuator assembly, monitoring the operating speed, and stopping the actuator assembly when the operating speed decreases to indicate that an end of the shaft is in contact with the ground.

The invention also provides a method of calibration including calculating a front-rear distance between the shafts and a left-right distance between the shafts based on measuring a change in inclination over a known calibration extension distance.

The invention also provides a method of leveling a vehicle including activating the actuator assemblies to lower the shafts downwardly into contact with the ground beneath the vehicle. The plurality of actuator assemblies are then activated again, to lower the shafts an additional compacting distance. One of the shafts corresponding to a corner of the vehicle is defined as a highest shaft by measuring a front-rear inclination of the vehicle and a left-right inclination of the vehicle. For each remaining shaft other than the highest shaft a necessary extension distance is determined as the distance that the remaining shafts will be moved based on at least one of the front-rear inclination and the left-right inclination of the vehicle. The actuator assemblies corresponding to the remaining shafts are activated to move the remaining shafts the necessary extension distances to level the vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a portion of a vehicle structure inverted with four jack assemblies and shafts extending upwardly away from the vehicle structure;

FIG. 2 is a system diagram of a vehicle leveling assembly according to an exemplary embodiment of the present invention;

FIG. 3 is a perspective view of an integrated position sensor according to the exemplary embodiment;

FIG. 4 is an example of an operator interface showing a first dynamic view;

FIG. 5 is an example of the operator interface showing a second dynamic view;

FIG. 6 is a flow-chart showing an exemplary method of configuring an electronic control unit;

FIG. 7 is a flow-chart showing an exemplary method of detecting contact with the ground;

FIG. 8 is a flow-chart showing an exemplary method of calibrating the vehicle leveling assembly; and

FIG. 9 is a flow-chart showing an exemplary method of leveling a vehicle.

### DETAILED DESCRIPTION OF THE INVENTION

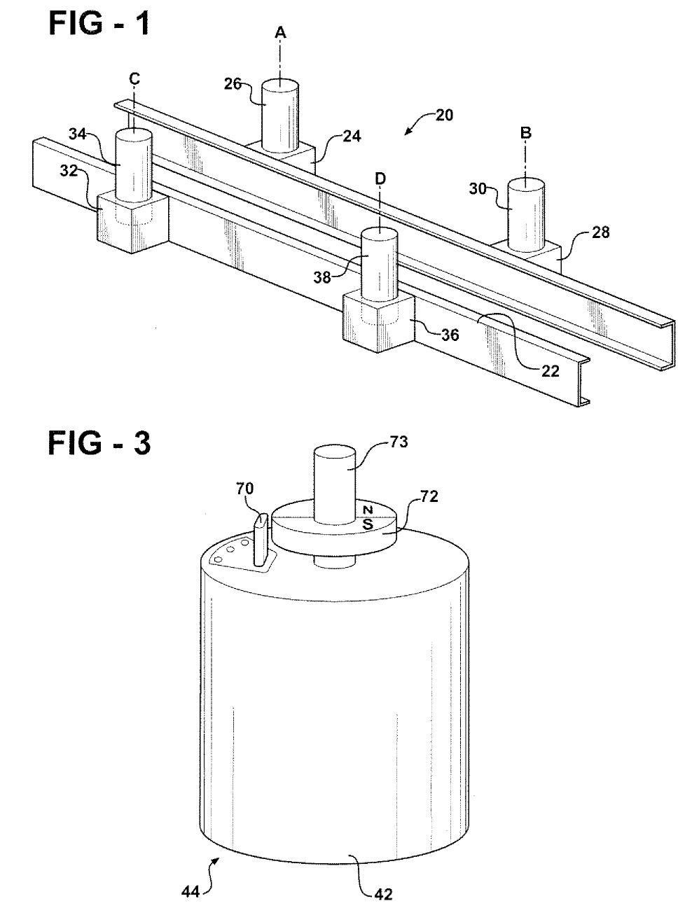

Referring to the Figures, wherein like numerals indicate corresponding parts throughout the several views, a vehicle leveling assembly is generally indicated at 20. Referring first to FIG. 1, the vehicle leveling assembly 20 is shown as being attached to a vehicle structure 22. For convenience, the vehicle structure 22 is shown in isolation without other chassis components, and is inverted to more easily display the vehicle leveling assembly 20. A first Jack assembly 24 is attached to the vehicle structure 22 in a first quadrant, corresponding to a front-left quadrant of the vehicle (not shown). The first quadrant also corresponds with a driver's side of a left-side drive vehicle. The first jack assembly 24 includes a first shaft 26 translatable about a first axis A relative to the vehicle structure 22. A second jack assembly 28 is attached to the vehicle structure 22 in a second quadrant disposed rearwardly of the first quadrant, corresponding to a rear-left quadrant of the vehicle (not shown). The second jack assembly 28 includes a second shaft 30 translatable about a second axis B relative to the vehicle structure 22. A third jack assembly 32 is attached to the vehicle structure 22 in a third quadrant disposed rightwardly of the first quadrant, corresponding to a front-right quadrant of the vehicle (not shown). The third jack assembly 32 includes a third shaft 34 translatable about a third axis C relative to the vehicle structure 22. A fourth jack assembly 36 is attached to the vehicle structure 22 in a fourth quadrant disposed rightwardly of the second quadrant, corresponding to a rear-right quadrant of the vehicle (not shown). The fourth jack assembly 36 includes a fourth shaft 38 translatable about a fourth axis D relative to the vehicle structure 22.

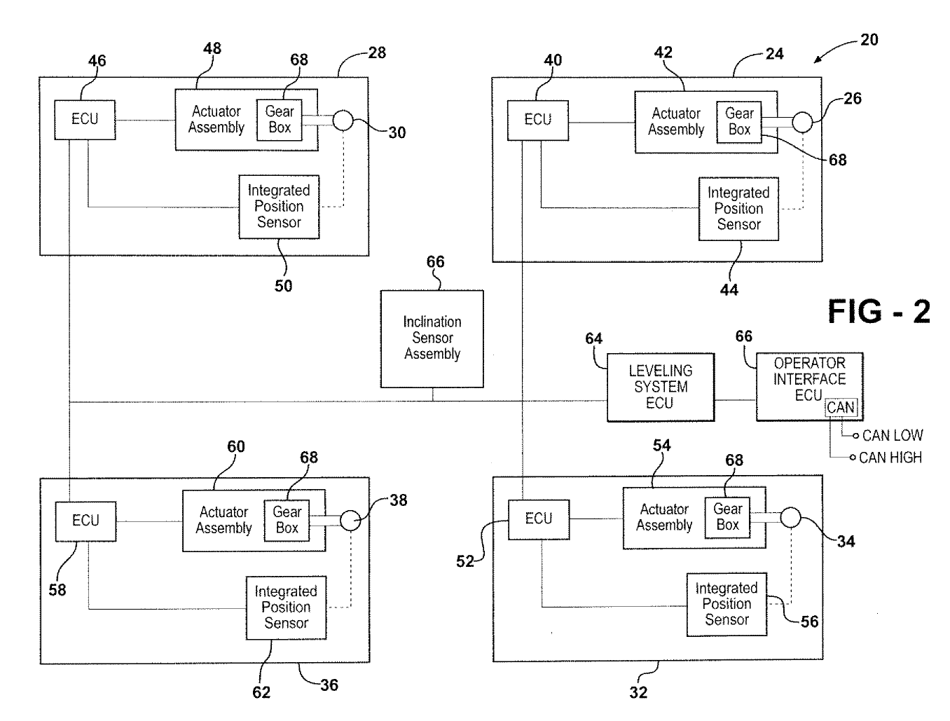

Additional detail of the jack assemblies 24, 28, 32, 36 is provided, with reference to the system diagram of FIG. 2. The single solid lines connecting elements in FIG. 2 represent electrical connection, whereas the double solid lines in FIG. 2 represent mechanical connection. The first jack assembly 24 includes a first electronic control unit 40 electrically connected to a first actuator assembly 42 and a first integrated position sensor 44. The second jack assembly 28 includes a second electronic control unit 46 electrically connected to a second actuator assembly 48 and a second integrated position sensor 50. The third jack assembly 32 includes a third electronic control unit 52 electrically connected to a third actuator assembly 54 and a third integrated position sensor 56. The fourth jack assembly 36 includes a fourth electronic control unit 58 electrically connected to a fourth actuator assembly 60 and a fourth integrated position sensor 62. The integrated position sensors 44, 50, 56, 62 provide a signal to the electronic control units 40, 46, 52, 58 to allow the electronic control units 40, 46, 52, 58 to determine position, velocity and acceleration of the shafts 26, 30, 34, 38 along the axes A, B, C, D and that signal is received by the electronic control units 40, 46, 52, 58 via the electrical connection. The electronic control units 40, 46, 52, 58 are all electrically connected to a leveling system electronic control unit 64, which is provided to receive and transmit instructions from an operator interface electronic control unit 66 as described herein.

The leveling system electronic control unit 64 is in communication with the electronic control units 40, 46, 52, 58 through a serial interface, such as a LIN, CAN or other known serial interface. Additionally, the actuator assemblies 42, 48, 54, 60 are independently responsive to the electronic control units 40, 46, 52, 58. The leveling system electronic control unit 64 is in communication with the operator interface control unit 66 which is configured to receive a vehicle status signal from a vehicle bus system, such as an RV-CAN bus system. Alternatively, the leveling system electronic control unit 64 may be directly connected to the RV-CAN bus system. The vehicle status signal may be a vehicle transmission status, parking break engagement, foot break engagement, or an ignition status. Alternatively, however, the vehicle leveling system 20 could be directly wired to individual assemblies within the vehicle structure 22 to receive such vehicle status information.

The leveling system electronic control unit 64 is provided with the vehicle leveling assembly 20 to determine a front-rear inclination θ₁ of the vehicle and a left-right inclination θ₂ of the vehicle. The leveling system electronic control unit 64 uses a dual axis inclination sensor. Alternatively, however, two single axis inclination sensors could be used, with one measuring the front-rear inclination θ₁, and the other measuring the left-right inclination θ₂. In addition, the leveling system electronic control unit 64 uses a two-axis micro-electro-mechanical tilt sensor. As the inclination of the vehicle changes, the signal emitted by the sensor is altered, allowing the leveling system electronic control unit 64 to read the angle of inclination. Alternative types of tilt sensors include electrolytic fluid sensors, capacitive sensors, and pendulum type sensors.

Referring to FIG. 2, the actuator assemblies 42, 48, 54, 60 have an electric motor generating rotational motion and being mechanically connected to a gearbox 68. The gears within the gearbox 68 are mechanically connected to the shafts 26, 30, 34, 38 and convert the rotational motion of the electric motor into linear motion to drive the shafts 26, 30, 34, 38. As shown in FIG. 3, the first integrated position sensor 44 includes a hall effect sensor 70 positioned in proximity to a magnet 72. Although only the first integrated position sensor 44 is shown in FIG. 3, it should be understood that the second, third and fourth integrated position sensors 50, 56, 62 include the same structure. The magnet 72 is placed on a rotating shaft 73 of the first actuator assembly 42. The hall effect sensor 70 is a type of transducer that produces a variable output signal in response to changes in magnetic field density. Therefore, as the magnet 72 rotates, the polarity causes the magnetic field relative to the hall effect sensor 70 to change in cyclic fashion. The hall effect sensor 70 produces a pulse of current in response to rotation of the magnet 72. The electronic control units 40, 46, 52, 58 are in communication with the integrated position sensors 44, 50, 56, 62 for detecting the pulses of current emitted by the hall effect sensor 70 to determine the position of the shafts 26, 30, 34, 38. The electronic control units 40, 46, 52, 58 are also configured to measure the pulse width to determine the rate of movement of the shafts 26, 30, 34, 38. The electronic control units 40, 46, 52, 58 communicate with the actuator assemblies 42, 48, 54, 60 to stop the actuator assemblies 42, 48, 54, 60 when the rate of movement decreases. The decreasing rate of movement indicates that the shaft has contacted the ground.

It should be understood that the use of the integrated position sensors 44, 50, 56, 62 may be replaced by other known detection devices such as a commutator pulse detection circuit. If a commutator pulse detection circuit is used, the integrated position sensors are not installed with electric motors. Instead, with the commutator pulse detection circuit, the electric motor current is measured by each corresponding electronic control unit 40, 46, 52, 58. The motor current is conditioned and contains a pulse created as the magnetic field collapses in the rotor coil between two commutator segments. The time between the pulses is correlated to the electric motor revelations per minute and the actuator travel similar to the hall effect sensor.

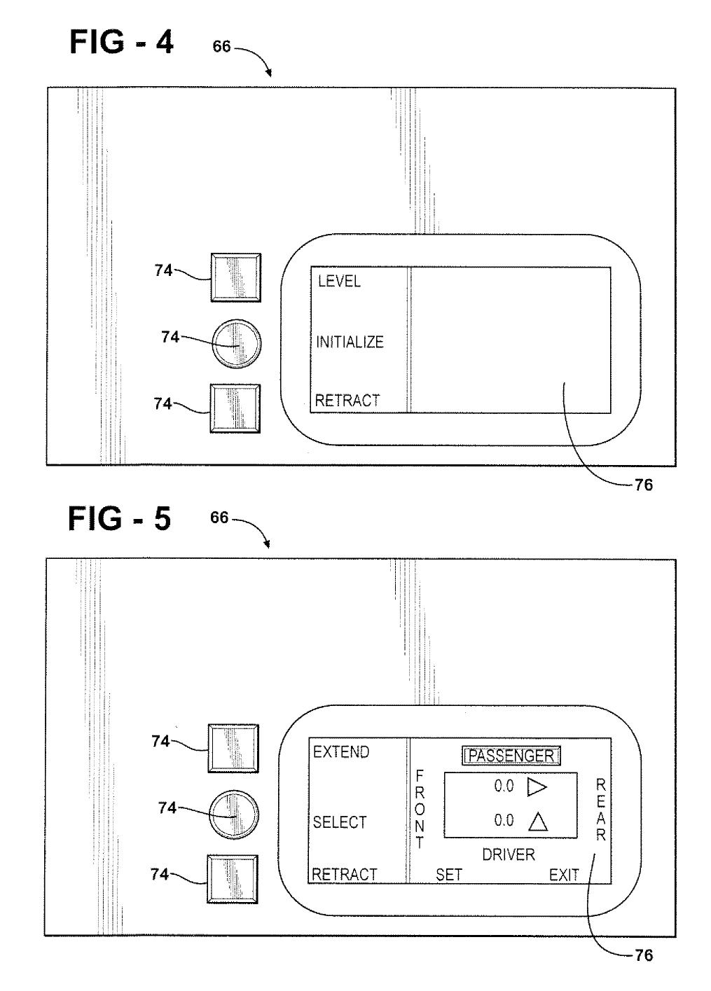

Referring to FIGS. 4 and 5, the operator interface control unit 66 is shown and includes a plurality of soft-keys 74 and a liquid-crystal display 76. An operator may input instructions via the soft-keys 74, defined by the labels shown on the liquid-crystal display 76 in a plurality of dynamic views. The functions corresponding to the soft-keys 74 are defined by control logic of the operator interface control unit 66 so that the same soft-keys 74 can initiate different functions based on the labels shown in the corresponding liquid-crystal display 76, allowing for soft-key 74 functions to be redefined as the tasks change. In the present example, a first dynamic view is shown on the display in FIG. 4, where the three soft-keys 74 correspond to functions labeled “Level”, “Initialize” and “Retract”, respectively. If the operator were to press the soft-key 74 adjacent to the label marked “Level”, the operator interface control unit 66 would initiate a vehicle leveling method, described in more detail later. Similarly, if the operator were to press the soft-key 74 adjacent to the label marked “Retract”, the operator interface control unit 66 would send a command to the leveling system electronic control unit 66 to cause the leveling system control unit to communicate with the electronic control units 40, 46, 52, 58 to retract all four of the shafts 26, 30, 34, 38. If the operator were to press the soft-key 74 adjacent to the label marked “Initialize”, the dynamic view would change to a second dynamic view, shown in FIG. 5. The second dynamic view includes three new labels for the soft-keys 74, including “Extend”, “Select” and “Retract”, respectively. These new labels could relate, for example, to manual operation of the vehicle leveling assembly 20, as opposed to an automated operation. In addition, the liquid-crystal display 76 includes additional information regarding which of the four jack assemblies 24, 28, 32, 36 is currently being controlled. The liquid-crystal display 76 can also be used by the vehicle leveling system 20 to convey information to the operator, such as a necessary warning message advising the operator not to engage in specified activity. Finally, the operator interface control unit 66 could also include a diagnostic mode accessible by manufacturers and dealers seeking to service or repair the vehicle leveling system 20. It should be understood that the operator interface control unit 66 may be configured or designed in many various ways including, for example, a vacuum florescent, OLED, plasma, or cathode ray tube may be used instead of the liquid-crystal display.

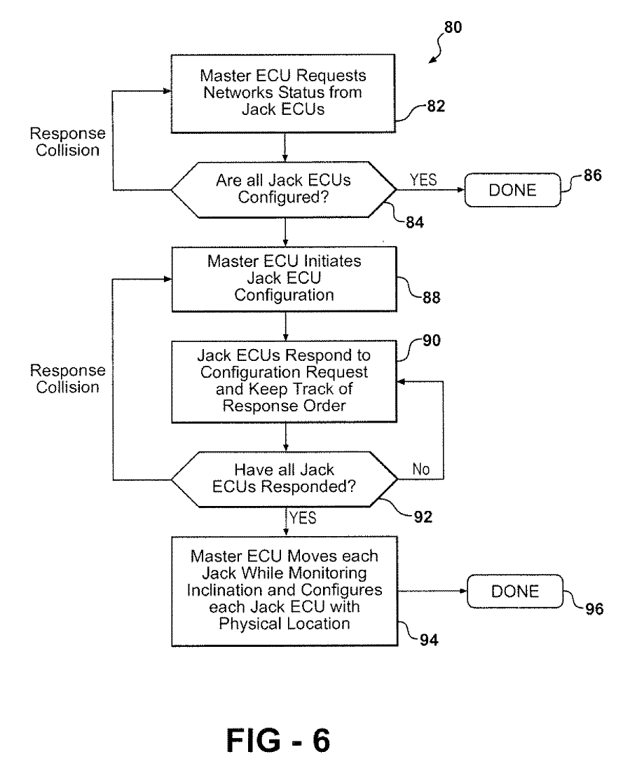

One of the functions, shown in FIG. 6, includes a method of configuring a vehicle leveling assembly 20, generally shown at 80. At step 82, the operator interface control unit 66 requests a network status from each one of the electronic control units 40, 46, 52, 58 via the leveling system control unit 66 and receives responses indicating whether the electronic control units 40, 46, 52, 58 have been configured. The responses for configured electronic control units 40, 46, 52, 58 will contain a unique physical identification and will be transmitted after a specified delay. The responses for unconfigured electronic control units 40, 46, 52, 58 will inform the operator interface control unit 66 of that status, and will be transmitted in a random manner to prevent response collisions on the network,

At step 84, the responses are interpreted to determine if any of the electronic control units 40, 46, 52, 58 are previously configured. If all electronic control units 40, 46, 52, 58 are configured, the method 80 will proceed to step 86 and terminate. If a response collision is detected, the method 80 will return to step 82 and re-request the network status. If one or more of the electronic control units 40, 46, 52, 58 are not configured, the method 80 will proceed to step 88.

At step 88, the leveling system electronic control unit 64 will initiate the specific configuration process, and will first clear any previous configuration of the electronic control units 40, 46, 52, 58. Next, the responses from the cleared electronic control units 40, 46, 52, 58 will be received randomly. At step 90, each electronic control unit is assigned a temporary physical identifier based on the order of responses received. At step 92, the method 80 will verify that all electronic control units 40, 46, 52, 58 have responded. If they have not, the method 80 will return to step 92. If a response collision is detected, the method 80 will return to step 88.

At step 94, the first jack assembly 24 is extended. A measurement, such as the angle of inclination resulting from the extension, is received from the inclination sensor. This measurement is interpreted to determine the physical location of the first jack assembly 24. The first electronic control unit 40 is assigned a first permanent physical identifier associated with that location. Step 94 is repeated for each of the second, third and fourth jack assemblies 28, 32, 36. Once all jack assemblies 24, 28, 32, 36 are configured, the exemplary method proceeds to step 96 and terminates.

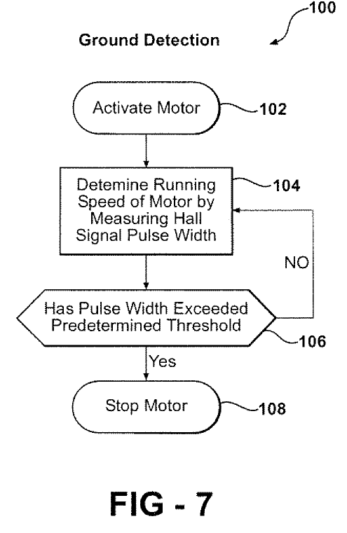

Another of the functions, shown in FIG. 7, includes a method of detecting contact with the ground, generally shown at 100. Although this method 100 is described with respect to the first jack assembly 24, it should be understood that all jack assemblies 24, 28, 32, 36 can perform the method of detecting contact with the ground. At step 102, the first actuator assembly 42 is activated to extend the shaft downwardly from the vehicle toward the ground. At steps 104, a rate of movement of the shaft is determined using the first integrated position sensor 44. The first electronic control unit 40 continues to monitor the rate of movement, and determines whether the rate is decreasing. If the rate of movement remains constant, then the first electronic control unit 40 continues monitoring. At step 106, the method 100 determines if the rate of movement has decreased beyond a predetermined threshold. As long as the threshold has not been exceeded, the method 100 returns to step 104 and continues monitoring the rate of movement. If the threshold has been exceeded, the method 100 proceeds to step 108, and the first electronic control unit 40 stops the first actuator assembly 42, as an indication that an end of the first shaft 26 is in contact with the ground.

As previously described, the hall effect sensor 70 of the first integrated position sensor 44 produces a pulse of current responsive to movement of the first actuator assembly 42, at step 104. Determining the rate of movement of the first shaft 26 is further described as measuring the pulse width to determine the rate. To produce the pulse of current, a magnetic field is emitted from a periodically moving member of the actuator assembly 42, such as the magnet 72 located in the gearbox 68, and changes in magnetic field density and polarity, are detected as the periodically moving member of the actuator assembly 42 changes position. Alternatively, the periodically moving member of the actuator assembly 42 could also be a reciprocating, or oscillating member, depending on the type of actuator assembly used.

Use of the integrated position sensors 44, 50, 56, 62 allows the electronic control units 40, 46, 52, 58 to determine the position of the first shaft 26 in relation to the vehicle, in addition to the speed. Therefore, the electronic control units 40, 46, 52, 58 know whether the shafts 26, 30, 34, 38 are filly retracted, or whether they are partially retracted or in contact with the ground. Therefore, there is no need to provide a clutch in connection with the actuator assemblies 42, 48, 54, 60, as the electronic control units 40, 46, 52, 58 determine the precise position at which to stop the shafts 26, 30, 34, 38 to prevent damage to the actuator assemblies 42, 48, 54, 60. In addition, the leveling system electronic control unit 64 can communicate with the vehicle bus, either via the operator interface control unit 66 or directly, to perform certain functions such as to prevent the vehicle transmission from shifting the vehicle powertrain out of the “PARK” position as long as any of the shafts 26, 30, 34, 38 are not fully retracted.

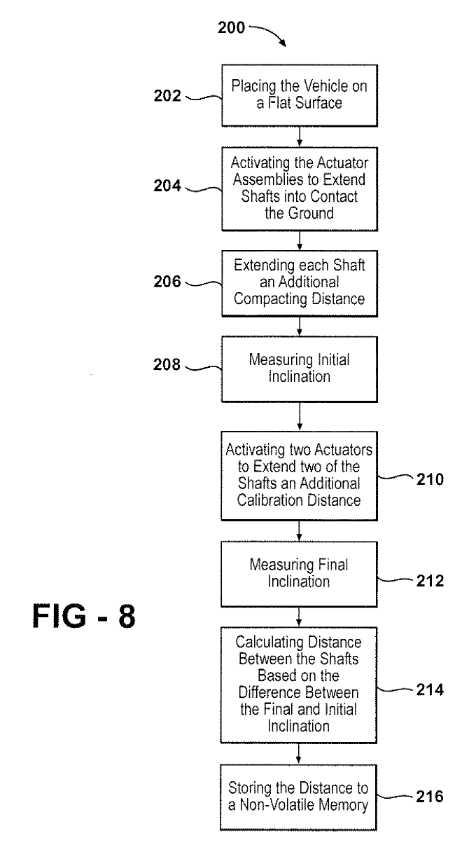

Another of the functions, shown in FIG. 8, is an exemplary method of calibrating a vehicle leveling assembly 20, generally shown at 200. In order to calibrate the vehicle leveling assembly 20, the leveling system electronic control unit 64 must know the distances in both the front-rear direction and the left-right direction between the jack assemblies 24, 28, 32, 36. This can be determined in a number of ways, including simply entering in known values for such distances. However, where such distances are not known in advance, the operator interface control unit 66, in cooperation with the leveling system electronic control unit 64, can include the method 200 of calibrating the vehicle leveling assembly 20 for calculating such distances as part of a calibration system.

At step 202, the vehicle is first moved on a flat surface. At step 204, the actuator assemblies 42, 48, 54, 60 are activated to each extend their respective shafts 26, 30, 34, 38 downwardly from the vehicle into contact with the ground. At step 206, the actuator assemblies 42, 48, 54, 60 extend each of the shafts 26, 30, 34, 38 an additional compacting distance to ensure the ground beneath each of the shafts 26, 30, 34, 38 is sufficiently compacted. This provides for a more accurate calculation as it prevents shifting of the inactive shafts 26, 30, 34, 38 during the calibration process. According to this embodiment, the additional compacting distance is approximately half an inch. At step 208, a front-rear inclination θ₁ of the vehicle is measured by the inclination sensor assembly 66 to determine an initial front-rear inclination θ₁ᵢ. At step 210, at least two of the four actuator assemblies 42, 48, 54, 60 are activated. The two assemblies correspond to the two of the four shafts 26, 30, 34, 38 positioned adjacent either a front or a rear portion of the vehicle, and extend the selected two of the four shafts 26, 30, 34, 38 downwardly a first calibration distance Y_{1C} At step 212, the front-rear inclination θ₁ is measured again to determine a final front-rear inclination θ_{1f}. At step 214, a front-rear distance X₁ between the front shafts 26, 34 and the rear shafts 38, 30 is calculated according to equation (1), based on the first calibration distance Y_{1C} and the difference between the final front-rear inclination θ_{1f} and the initial front-rear inclination θ₁ᵢ:

X₁=Y_{1C}/tan(Θ_{1f}−Θ₁ᵢ) (1)

At step 214, the front-rear distance X₁ is saved into a non-volatile memory of the vehicle leveling assembly 20 for use with future calculations.

According to this embodiment, this method is carried out by the operator interface control unit 66, in cooperation with the leveling system electronic control unit 64 to read an initial front-rear inclination θ₁ᵢ. The leveling system electronic control unit 64 activates the second and fourth jack assemblies 28, 36 and the second and fourth actuator assemblies 48, 60 to extend the second and fourth shafts 30, 38 by the first calibration distance Y_{1C}. According to this embodiment, the first calibration distance Y_{1C} is five inches. The leveling system electronic control unit 64 checks the inclination sensor assembly 66 to read the final front-rear inclination θ_{1f}. The leveling system electronic control unit 64 calculates the front-rear distance X₁ according to equation (1). Alternatively, the operator interface control unit 66 could complete the same computation by extending the first and third jack assemblies 24, 32, instead of the second and fourth jack assemblies 28, 36.

The leveling system electronic control unit 64 conducts a similar calculation to determine the left-right distance X₂ between the jack assemblies 24, 28, 32, 36. First, the actuator assemblies 42, 48, 54, 60 are activated to return the vehicle to the initial front-rear inclination θ₁ᵢ. Then, a left-right inclination θ₂ of the vehicle is measured to determine an initial left-right inclination θ₂ᵢ. Next, the selected two of the four actuator assemblies 42, 48, 54, 60 that correspond to two of the four shafts 26, 30, 34, 38 positioned laterally along either the left or right side of the vehicle are activated to extend downwardly a second calibration distance Y_{2C}. The left-right inclination θ₂ of the vehicle is measured again to determine a final left-right inclination θ_{2f}. The left-right distance X₂ between the left shafts 26, 30 and the right shafts 38, 34 is then calculated according to equation (2) based on the second calibration distance Y_{2C} and the difference between the final and initial left-rear inclination:

X₂=Y_{2C}/tan(Θ_{2f}−Θ₂ᵢ) (2)

This method is also carried out by the leveling system electronic control unit 64, which communicates with the inclination sensor assembly 66 to determine the initial left-right inclination θ₂ᵢ, and then activates the third and fourth jack assemblies 32, 36 to extend the third and fourth shafts 34, 38 by the second calibration distance Y_{2C}. According to this embodiment, the second calibration distance Y_{2C} is five inches. The leveling system electronic control unit 64 then compares the initial left-right inclination θ₂ᵢ to the final left-right inclination θ_{2f} and calculates the left-right distance X₂ according to equation (2). Alternatively, the leveling system electronic control unit 64 could complete the same computation by extending the first and second jack assemblies 24, 28, instead of the third and fourth jack assemblies 32, 36. Either way, the left-right distance X₂ between the shafts 26, 30, 34, 38 is stored into the non-volatile memory of the vehicle leveling assembly 20.

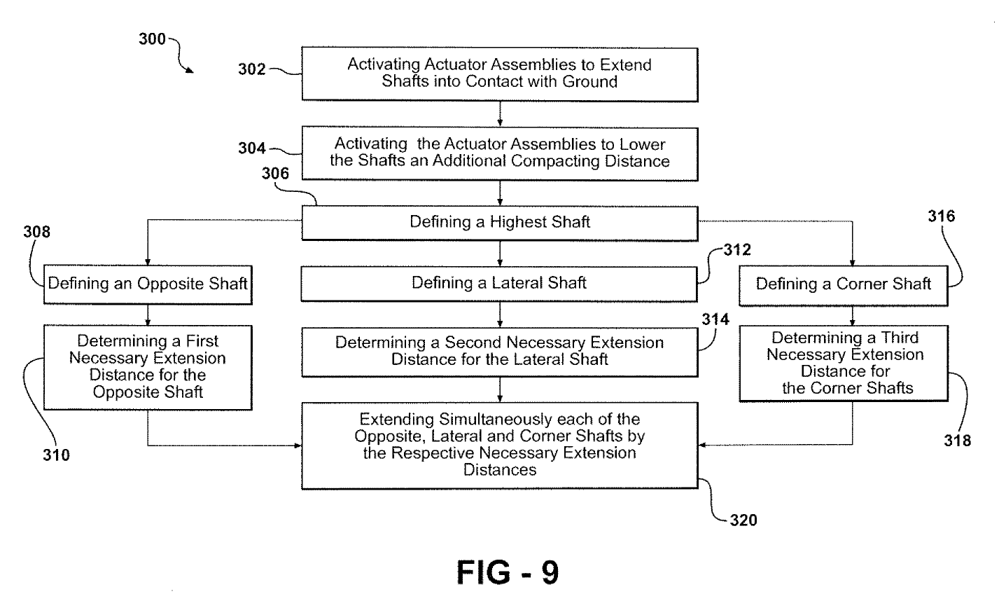

Finally, referring to FIG. 9, the functions of the leveling system electronic control unit 64 include a method of leveling a vehicle, generally shown at 300. Upon receiving a command to begin the leveling process, the actuator assemblies 42, 48, 54, 60 are activated at step 302 to each lower the shafts 26, 30, 34, 38 downwardly into contact with the ground beneath the vehicle. At step 304, in order to eliminate shifting of the ground beneath the vehicle, the actuator assemblies 42, 48, 54, 60 are again activated to extend each shaft by an additional compacting distance. This ensures sufficient compaction of the ground so that the leveling process need not be repeated. According to this method 300, the additional compacting distance is approximately half an inch. At step 306, one of the shafts 26, 30, 34, 38 is designated as a highest shaft, corresponding to the highest corner of the vehicle, as determined by measuring the front-rear inclination θ₁ and the left-right inclination θ₂. At steps 308-318, for each remaining shaft other than the highest shaft, a necessary extension distance must be determined. This is the distance that the remaining shafts 26, 30, 34, 38 will be moved based on the front-rear inclination θ₁ and the left-right inclination θ₂ of the vehicle. The actuator assemblies 42, 48, 54, 60 corresponding to those remaining shafts 26, 30, 34, 38 are activated to move the remaining shafts 26, 30, 34, 38 the necessary extension distances, thereby leveling the vehicle.

The method 300 further includes comparing each of the necessary extension distances to an available stroke of each shaft and determining whether each shaft is available to travel the additional distance. If at least one of the additional distances is greater than the available stroke, the operator interface control unit 66 warns an operator that leveling may not be possible in this location.

This method 300 is carried out by the leveling system electronic control unit 64, by reading the output of the inclination sensor assembly 66. By receiving the front-rear inclination θ₁ and the left-right inclination θ₂, the leveling system electronic control unit 64 is able to communicate with the electronic control units 40, 46, 52, 58 to designate one of the four shafts 26, 30, 34, 38 as a highest shaft. The highest shaft is the shaft corresponding to the highest elevation of the vehicle, and therefore will have to be adjusted the least, with the other three of the four shafts 26, 30, 34, 38 adjusting to bring the other three corners of the vehicle up. At step 308, the shaft on the same left-right side of the highest shaft and at the opposite end of the vehicle in a front-rear direction is designated as an opposite shaft. At step 310, the leveling system electronic control unit 64 calculates a first necessary extension Y₁ of the opposite shaft according to equation (3) based on the stored value of the front-rear distance X₁ between the shafts 26, 30, 34, 38 and the front-rear inclination θ₁ as retrieved from the inclination sensor assembly 66:

Y₁=X₁ X tan Θ₁ (3)

At step 312, the shaft across from the highest shaft in a left-right direction, and at the same end in the front-rear direction, is designated as a lateral shaft. At step 314, the leveling system electronic control unit 64 calculates a second necessary extension Y₂ of the lateral shaft according to equation (4) based on the stored value of the left-right distance X₂ between the shafts 26, 30, 34, 38 and the left-right inclination θ₂ as retrieved from the inclination sensor assembly 66:

Y₂=X₂ tan Θ₂ (4)

At step 316, the remaining shaft, located both across from the highest shaft and at the opposite end of the vehicle, is designated as a corner shaft. At step 318, the leveling system electronic control unit 64 calculates a third necessary extension Y₃ of the corner shaft according to the equation (5) based on the values of the first and second necessary extensions Y₁, Y₂:

Y₃=Y₁+Y₂ (5)

At step 320, once the necessary extensions have been calculated, the leveling system electronic control unit 64 instructs the electronic control units 40, 46, 52, 58, and in turn the actuator assemblies 42, 48, 54, 60, to activate their respective shafts 26, 30, 34, 38 to extend precisely the required distance. In addition, due to the additional step of extending the shafts 26, 30, 34, 38 the additional compacting distance, this adjustment only needs to be made once, rather than repeating the process several times to achieve the desired attitude.

Obviously, many modifications and variations of the present invention are possible in light of the above teachings and may be practiced otherwise than as specifically described while within the scope of the appended claims.

What is claimed is:

1. A method of configuring a vehicle leveling system comprising the steps of:
extending a first jack assembly associated with a first electronic control unit,.
receiving a command from a leveling system electronic control unit,
interpreting the measurement to determine the physical location of the first jack assembly, and
assigning the first electronic control units a first permanent physical identifier.

2. A method as set forth in claim 1 further defined as repeating each of said steps for each of a plurality of remaining jack assemblies and associated electronic control units.

3. A method as set forth in claim 2 further defined as requesting a network status from each one of the plurality of electronic control units and receiving responses from the electronic control units prior to said step of extending the first jack assembly.

4. A method as set forth in claim 3 further defined as assigning each electronic control unit a temporary physical identifier based on the order of responses received.

5. A method as set forth in claim 3 further defined as interpreting the responses to determine if any of the electronic control units are previously configured.

6. A method as set forth in claim 5 wherein said step of interpreting is further defined as receiving unconfigured responses in a random order.

7. A method as set forth in claim 6 wherein said interpreting is further defined as detecting a response collision and re-requesting a network status from the electronic control units.

8. A method as set forth in claim 3 further defined as clearing any previous configuration of the electronic control units.

9. A method of detecting contact with the ground in a vehicle leveling assembly comprising the steps of:
activating an actuator assembly connected to a shaft to extend the shaft downwardly relative to a vehicle toward the ground,
determining a rate of movement of the actuator assembly,
monitoring the rate of movement of the actuator assembly, and
stopping the actuator assembly when the rate of movement decreases indicating that an end of the shaft is in contact with the ground.

10. A method as set forth in claim 9 further defined as producing a pulse of current responsive to movement of the actuator assembly.

11. A method as set forth in claim 10 wherein said step of determining the rate of movement is further defined as measuring the width of the pulse to determine the rate of movement.

12. A method as set forth in claim 11 wherein said step of producing the pulse of current is further defined as emitting a magnetic field from a periodically moving member of the actuator assembly and detecting changes in the magnetic field from the periodically moving member and producing the pulse of current in response to changes in the magnetic field.

13. A method of calibrating a vehicle leveling assembly comprising:
placing the vehicle on a flat surface,
activating a plurality of actuator assemblies to each extend a shaft downwardly from the vehicle into contact with the ground,
measuring a front-rear inclination of the vehicle to determine an initial front-rear inclination,
activating at least two of the actuator assemblies corresponding to at least two shafts positioned adjacent either a front or a rear portion of the vehicle to extend the at least two shafts downwardly a first calibration distance,
measuring the front-rear inclination of the vehicle to determine a final front-rear inclination, and
calculating a front-rear distance between the shafts along the front and the shafts along the rear of the vehicle according to the equation X₁=Y₁/tan(Θ_{1f}−Θ₁ᵢ).

14. A method as set forth in claim 13 further defined as activating the actuator assemblies to extend each of the shafts an additional compacting distance to ensure the ground beneath each of the shafts is sufficiently compacted prior to measuring the front-rear inclination of the vehicle to determine the initial front-rear inclination.

15. A method as set forth in claim 14 wherein said step of activating the actuator assemblies to extend each of the shafts the additional compacting distance includes operating the actuator assemblies to extend each of the shafts downwardly about 0.5 inches.

16. A method as set forth in claim 13 further defined as storing the front-rear distance into a non-volatile memory of the vehicle leveling assembly.

17. A method as set forth in claim 13 further defined as:
activating the at least two actuator assemblies corresponding to at least two shafts positioned adjacent either the front or the rear portion of the vehicle to retract upwardly the first calibration distance to return the front-rear inclination of the vehicle to the initial front-rear inclination,
measuring a left-right inclination of the vehicle to determine an initial left-right inclination,
activating at least two actuator assemblies corresponding to at least two shafts positioned laterally along either the left or right side of the vehicle to extend the at least two shafts downwardly a second calibration distance,
measuring the left-right inclination of the vehicle to determine a final left-right inclination, and
calculating a left-right distance between the shafts along the left side and the shafts along the right side of the vehicle according to the equation X₂=Y₂/tan(Θ_{2f}−Θ₂ᵢ).

18. A method as set forth in claim 17 further defined as storing the left-right distance into a non-volatile memory of the vehicle leveling assembly.

19. A method of leveling a vehicle comprising:
activating a plurality of actuator assemblies to each lower a shaft downwardly into contact with the ground beneath the vehicle,
activating the plurality of actuator assemblies to each lower the shafts an additional compacting distance prior to said defining step,
defining one of the shafts corresponding to a corner of the vehicle as a highest shaft by measuring a front-rear inclination of the vehicle and a left-right inclination of the vehicle,
determining for each remaining shaft other than the highest shaft a necessary extension distance that the remaining shafts will be moved based on at least one of the front-rear inclination and the left-right inclination of the vehicle, and
activating the actuator assemblies corresponding to the remaining shafts to move the remaining shafts the necessary extension distances to level the vehicle.

20. A method as set forth in claim 19 wherein said step of determining the necessary extension distances is further defined as:
determining a first necessary extension distance for an opposite shaft positioned at an opposite end of the vehicle in a front-rear direction from the highest shaft by recalling a front-rear distance between the highest shaft and the opposite shaft and calculating the first additional distance according to the equation Y₁=X₁ tan Θ₁,
determining a second necessary extension distance for a lateral shaft positioned across from the highest shaft in a left-right direction by recalling a left-right distance between the highest shaft and the lateral shaft and calculating the second additional distance according to the equation Y₂=X₂ tan Θ₂, and
calculating a third necessary extension distance for a corner shaft positioned at the opposite end of the vehicle in a front-rear direction and across from the highest shaft in the left-right direction according to the equation Y₃=Y₁+Y₂.

21. A method as set forth in claim 20 further defined as activating the actuator assemblies to extend the opposite shaft and the lateral shaft and the corner shaft by the first and second and third necessary extension distances to level the vehicle.

22. A method as set forth in claim 20 wherein said step of activating the actuator assemblies to lower the shafts the additional compacting distance is further defined as activating the actuator assemblies to lower the shafts an additional 0.5 inches to ensure sufficient compaction of the ground beneath the vehicle.

23. A method as set forth in claim 20 further defined as comparing each of the necessary extension distances to an available stroke of each shaft and determining whether each shaft is available to travel the additional distance.

24. A method as set forth in claim 23 further defined as warning an operator if at least one of the additional distances is greater than the available stroke of the corresponding shaft.
